(19) United States
(12) Patent Application Publication
(10) Pub. No.: US 2005/0127846 A1
(43) Pub. Date: Jun. 16, 2005

(54) Apparatus and method for driving plasma display panel

(76) Inventor: Yong Duek Kim, Seo-gu (KR)

Correspondence Address: MCKENNA LONG & ALDRIDGE LLP;Song K. Jung, 1900 K Street, N.W., Washington, DC, 20006, US

(21) Appl. No.: 11/000,497

(22) Filed: Dec. 1, 2004

(30) Foreign Application Priority Data
Dec. 1, 2003 (KR) 10-2003-0086376

(51) Int. Cl. G09G 3/10

(52) U.S. Cl. 315/169.4; 315/291

(57) ABSTRACT

Disclosed herein is an apparatus and method for driving a plasma display panel in which brightness of the panel can be controlled corresponding to the ambient brightness. According to the present invention, the method for driving the plasma display panel includes the steps of sensing the ambient brightness at a location where the panel is disposed, and controlling the brightness of the panel corresponding to the sensed brightness. Furthermore, the apparatus for driving the plasma display panel includes a plurality of driving units for driving electrodes formed in the panel, a timing controller for controlling the driving units, and a brightness sensor for sensing the ambient brightness at a location where the panel is disposed, wherein the timing controller controls the driving units corresponding to the ambient brightness received from the brightness sensor.

This Nonprovisional application claims priority under 35 U.S.C. §119(a) on Patent Application No. 10-2003-0086376 filed in Korea on Dec. 1, 2003, the entire contents of which are hereby incorporated by reference.

### BACKGROUND OF THE INVENTION

1. Field of the Invention

The present invention relates to an apparatus and method for driving a plasma display panel and, more particularly, to an apparatus and method for driving a plasma display panel in which brightness of the panel can be controlled corresponding to the ambient brightness.

2. Description of the Background Art

A plasma display panel (hereinafter, referred to as a ‘PDP’) is adapted to display an image including characters or graphics by light-emitting phosphors with ultraviolet of 147 nm generated during the discharge of a gas such as He+Xe, Ne+Xe or He+Ne+Xe. This PDP can be easily made thin and large, and it can provide greatly increased image quality with the recent development of the relevant technology. Particularly, a three-electrode AC surface discharge type PDP has advantages of lower driving voltage and longer product lifespan as a voltage necessary for discharging is lowered by wall charges accumulated on a surface upon discharging and electrodes are protected from sputtering caused by discharging.

FIG.1 is a perspective view showing the construction of a discharge cell of a three-electrode AC surface discharge type PDP in a prior art.

Referring now to FIG. 1, a discharge cell of a three-electrode AC surface discharge type PDP includes a scan electrode Y and a sustain electrode Z which are formed on the bottom surface of an upper substrate 10, and an address electrode X formed on a lower substrate 18. The scan electrode Y includes a transparent electrode 12Y, and a metal bus electrode 13 which has a line width smaller than that of the transparent electrode 12Y and is disposed at one side edge of the transparent electrode. Further, the sustain electrode Z includes a transparent electrode 12Z, and a metal bus electrode 13Z which has a line width smaller than that of the transparent electrode 12Z and is disposed at one side edge of the transparent electrode.

The transparent electrodes 12Y and 12Z, which are generally made of ITO (indium tin oxide), are formed on the bottom surface of the upper substrate 10. The metal bus electrodes 13Y and 13Z are generally formed on the transparent electrodes 12Y and 12Z made of metal such as chromium (Cr), and serves to reduce a voltage drop caused by the transparent electrodes 12Y and 12Z having high resistance. On the bottom surface of the upper substrate 10 in which the scan electrode Y and the sustain electrode Z are placed parallel to each other is laminated an upper dielectric layer 14 and a protective layer 16. The upper dielectric layer 14 is accumulated with a wall charge generated during plasma discharging. The protective layer 16 is adapted to prevent damages of the upper dielectric layer 14 due to sputtering caused during plasma discharging, and improve efficiency of secondary electron emission. As the protective layer 16, magnesium oxide (MgO) is generally used.

A lower dielectric layer 22 and a barrier rib 24 are formed on the lower substrate 18 in which the address electrode X is formed. A phosphor layer 26 is applied to the surfaces of both the lower dielectric layer 22 and the barrier rib 24. The address electrode X is formed on the lower substrate 18 in the direction in which the scan electrode Y and the sustain electrode Z intersect with each other. The barrier rib 24 is in the form of stripe or lattice to prevent leakage of an ultraviolet and a visible light generated by discharging to an adjacent discharge cell. The phosphor layer 26 is excited with an ultraviolet generated during the plasma discharging to generate any one visible light of red, green and blue lights. An inert mixed gas is injected into the discharge spaces defined between the upper substrate 10 and the barrier ribs 24 and between the lower substrate 18 and the barrier ribs 24.

This PDP is driven with one frame being time-divided into a plurality of sub-fields having a different number of emission in order to implement the gray scale of an image. Each of the sub fields is divided into an initialization period for initializing the entire screen, an address period for selecting a scan line and selecting a cell from the selected scan line, and a sustain period for implementing the gray level according to the number of discharging.

In this time, the initialization period is divided into a set-up period where a ramp-up waveform is applied, and a set-down period where a ramp-down waveform is applied. If it is desired to display an image with 256 gray scales, a frame period (16.67 ms) corresponding to 1/60 seconds is divided into eight sub-fields SF1 to SF8, as shown in FIG. 2. Each of the sub-fields SF1 to SF8 is subdivided into the initialization period, the address period and the sustain period, as described above. The initialization period and the address period of each of the sub-fields SF1 to SF8 are the same every sub-field, whereas the sustain period increases in the ratio of 2n (where, n=0,1,2,3,4,5,6,7) in each sub-field.

FIG. 3 is a block diagram showing an apparatus for driving a PDP in a prior art.

Referring to FIG. 3, the conventional apparatus for driving the PDP includes an address driving unit 32 for driving address electrodes X1 to Xm disposed in a panel 30, a scan driving unit 34 for driving scan electrodes Y1 to Yn disposed in the panel 30, a sustain driving unit 36 for driving sustain electrodes Z1 to Zn disposed in the panel 30, a driving voltage generator 40 for supplying driving voltages to the driving units 32, 34 and 36, and a timing controller 38 for supplying control signals SCS1 to SCS3, DCLK to the driving units 32, 34 and 36.

The driving voltage generator 40 generates a variety of driving voltages so that a driving waveform as shown in FIG. 4 can be generated, and supplies the generated voltages to the address driving unit 32, the scan driving unit 34 and the sustain driving unit 36. For example, the driving voltage generator 40 generates voltages such as Vsetup, −Vw, Vr and Vs and supplies the voltages to the scan driving unit 34. It generates a voltage Vs and provides it to the sustain driving unit 36. Furthermore, the driving voltage generator 40 generates a voltage Va and provides it to the address driving unit 32.

The timing controller 38 generates a variety of the switching control signals so that the driving waveform as shown in FIG. 4 can be generated, and supplies the generated signals to the address driving unit 32, the scan driving unit 34 and the sustain driving unit 36. For example, the timing controller 38 generates a first switching control signal SCS1 and a second switching control signal SCS2 and supplies them to the scan driving unit 34 and the sustain driving unit 36, respectively. Also, the timing controller 38 generates a third switching control signal SCS3 and a data clock DCLK and supplies them to the address driving unit 32.

The address driving unit 32 serves to supply image data data, which is received from the outside, to the address electrodes X1 to Xm according to the data clock DCLK and the third switching control signal SCS3 which are outputted from the timing controller 38.

The scan driving unit 34 supplies a reset pulse, a scan pulse scan and a sustain pulse sus to the scan electrodes Y1 to Ym, according to the first switching control signal SCS1 outputted from the timing controller 38.

The sustain driving unit 36 supplies a positive polarity voltage (Vs), the sustain pulse sus and an erase pulse erase to the sustain electrodes Z1 to Zn, according to the second switching control signal SCS2 outputted from the timing controller 38.

The driving waveform applied to the electrodes will now be described in detail with reference to FIG. 4.

In the set-up period of the initialization period, a ramp-up waveform Ramp-up is applied to all the scan electrodes Y at the same time. A weak discharge is generated within cells of the entire screen by the ramp-up waveform Ramp-up, thus generating wall charges within the cells. In the set-down period, after the ramp-up waveform Ramp-up is applied, a ramp-down waveform Ramp-down, which falls from a voltage of the positive polarity that is lower than the peak voltage of the ramp-up waveform Ramp-up, is applied to the scan electrodes Y at the same time. The ramp-down waveform Ramp-down generates a weak erase discharge within the cells to erase the wall charges generated by a set-up discharge and unnecessary charges among space charges and also to allow the wall charges necessary for an address discharge to uniformly remain within the cells of the entire screen.

In the address period, simultaneous when the scan pulse scan of the negative polarity is sequentially applied to the scan electrodes Y, the data pulse data of the positive polarity is applied to the address electrodes X. As a voltage difference between the scan pulse scan and the data pulse data and the wall voltage generated in the initialization period are added, the address discharge is generated within cells to which the data pulse data is applied. The wall charges are generated within cells selected by the address discharge.

Meanwhile, in the set-down period and the address period, a positive polarity DC of the sustain voltage level (Vs) is applied to the sustain electrodes Z.

In the sustain period, the sustain pulse sus is alternately applied to the scan electrodes Y and the sustain electrodes Z. Then, in the cells selected by the address discharge, a sustain discharge is generated in a surface discharge shape between the scan electrodes Y and the sustain electrodes Z whenever every sustain pulse sus is applied as the wall voltage within the cells and the sustain pulse sus are added. After the sustain discharge is completed, an erase ramp waveform erase having a small pulse width is applied to the sustain electrodes Z to erase the wall charges within the cells.

In such a conventional PDP, brightness of the panel 30 is controlled regardless of the ambient brightness. If brightness of the panel 30 is controlled regardless of the ambient brightness, however, an optimum screen cannot be provided to a viewer.

For example, if the ambient brightness is dark, even a weak light generated from the panel 30 looks bright. Accordingly, if the ambient brightness is dark, black brightness represented on the panel 30 needs to be represented very dark. (i.e., if ambient environment of the panel 30 is dark, a viewer will not view the black screen well unless black brightness is represented very dark) That is, if the ambient brightness is dark, an image needs to be represented dark on the panel 30. In a prior art, however, brightness of the panel 30 is controlled regardless of the ambient brightness. It is thus impossible to provide an optimum brightness.

Meanwhile, if the ambient brightness is bright, a viewer cannot view the gray scale of a bright light generated from the panel 30. Accordingly, if the ambient brightness is bright, the white brightness represented on the panel 30 has to be represented high. That is, if ambient environment of the panel 30 is bright, a viewer cannot view the white screen unless the white brightness is presented very bright. In other words, if the ambient brightness is bright, the panel 30 must be controlled so that an image is represented on the panel bright. In a prior art, however, the brightness of the panel 30 is adjusted regardless of the ambient brightness. Accordingly, an optimum brightness cannot be provided.

### SUMMARY OF THE INVENTION

Accordingly, an object of the present invention is to solve at least the problems and disadvantages of the background art.

It is an object of the present invention to provide an apparatus and method for driving a plasma display panel in which the brightness of the panel can be adjusted corresponding to the ambient brightness.

To achieve the above object, according to the present invention, there is provided a method for driving a plasma display panel, including the steps of: sensing the ambient brightness at a location where the panel is disposed, and controlling the brightness of the panel corresponding to the sensed brightness.

According to the present invention, there is provided an apparatus for driving a plasma display panel, including: a plurality of driving units for driving electrodes formed in the panel, a timing controller for controlling the driving units, and a brightness sensor for sensing the ambient brightness at a location where the panel is disposed, wherein the timing controller controls the driving units corresponding to the ambient brightness received from the brightness sensor.

According to the present invention, there is provided an apparatus for driving a plasma display panel, including: a plurality of driving units for driving electrodes formed in the panel, a sub-field mapping unit for mapping data received from the outside to sub-field patterns stored therein and supplying the mapped results to one of the driving units, and a brightness sensor for sensing the ambient brightness at a location where the panel is disposed, wherein the sub-field mapping unit maps the data so that the number of the gray scale is converted corresponding to the ambient brightness received from the brightness sensor.

According to the present invention, there is provided an apparatus for driving a plasma display panel, including: a plurality of driving units for driving electrodes formed in the panel, a gain control unit for controlling a gain of data received externally, and a brightness sensor for sensing the ambient brightness at a location where the panel is disposed, wherein the gain control unit controls a gain value in order to expand or shrink the range of the gray scale to display an image corresponding to the ambient brightness received from the brightness sensor.

According to the present invention, if a location where a panel is disposed is bright, an image is displayed bright. If a location where a panel is disposed is dark, an image is displayed dark. Accordingly, the present invention is advantageous in that it can provide an optimum brightness corresponding to ambient environment.

### BRIEF DESCRIPTION OF THE DRAWINGS

The invention will be described in detail with reference to the following drawings in which like numerals refer to like elements.

FIG.1 is a perspective view showing the construction of a discharge cell of a three-electrode AC surface discharge type PDP in a prior art;

FIG. 2 shows an example of brightness weight in a PDP;

FIG. 3 is a block diagram showing an apparatus for driving a PDP in a prior art;

FIG. 4 shows a driving waveform applied to sub-fields of a conventional PDP;

FIG. 5 is a block diagram showing an apparatus for driving a PDP according to an embodiment of the present invention;

FIGS. 6 and 7 are views for explaining that a reset pulse is applied only to odd-numbered sub-fields by means of the timing controller shown in FIG. 5;

FIG. 8 is a view for explaining that a voltage value of a reset pulse is controlled corresponding to the ambient brightness by means of the timing controller shown in FIG. 5;

FIGS. 9a and 9b are views for explaining that the number of a sustain pulse is controlled corresponding to the ambient brightness by means of the timing controller shown in FIG. 5;

FIG. 10 is a block diagram showing an apparatus for driving a PDP according to another embodiment of the present invention;

FIG. 11 illustrates sub-field tables included in a sub-field mapping unit shown in FIG. 10; and

FIG. 12 is a block diagram showing an apparatus for driving a PDP according to still another embodiment of the present invention.

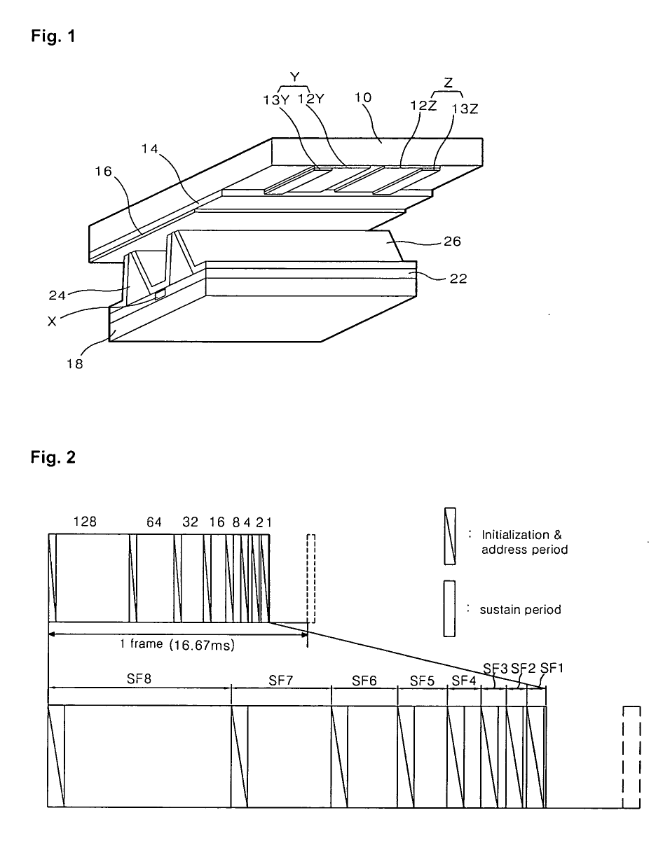

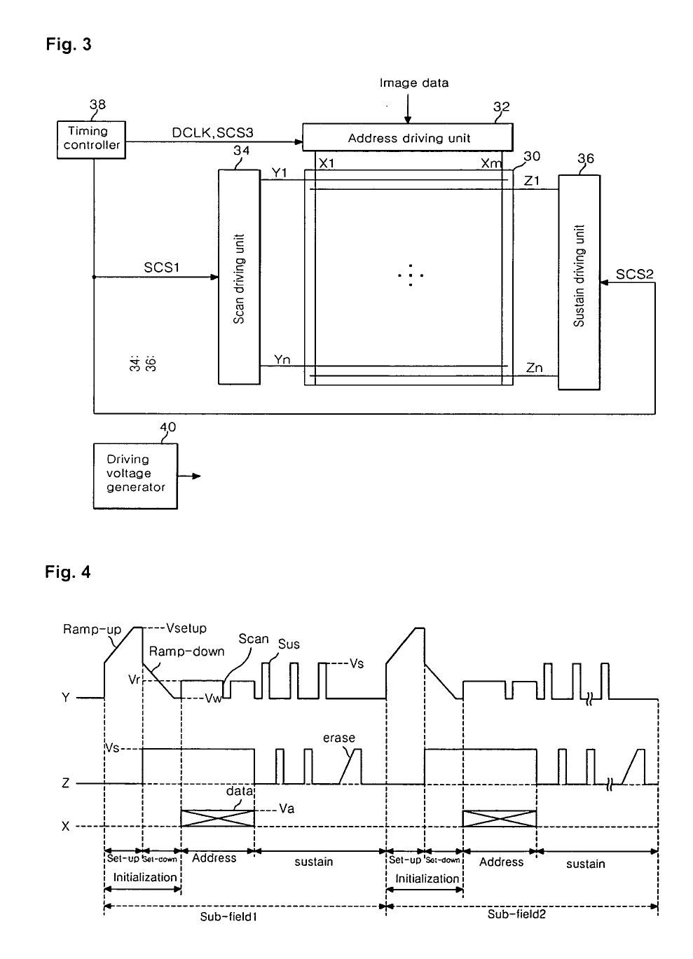

### DETAILED DESCRIPTION OF PREFERRED EMBODIMENTS

Preferred embodiments of the present invention will be described in a more detailed manner with reference to the drawings.

According to the present invention, there is provided a method for driving a plasma display panel, including the steps of: sensing the ambient brightness at a location where the panel is disposed, and controlling the brightness of the panel corresponding to the sensed brightness.

The step of controlling the brightness of the panel includes controlling the brightness of the panel to be bright when the sensed brightness is bright, and controlling the brightness of the panel to be dark when the sensed brightness is dark.

The step of controlling the brightness of the panel includes not applying a reset pulse in one or more of a plurality of sub-fields included in one frame when the sensed brightness is dark.

The reset pulse is applied in odd-numbered sub-fields of the plurality of the sub-fields, and the reset pulse is not applied in the remaining sub-fields.

In a sustain period of the odd-numbered sub-fields, an erase pulse is not applied.

The step of controlling the brightness of the panel includes the steps of if it is determined that the sensed brightness is not dark, applying a reset pulse having a first voltage value during a reset period of sub-fields, and if it is determined that the sensed brightness is dark, applying a reset pulse having a second voltage value different from the first voltage value during the reset period.

The second voltage value is set to be lower than the first voltage value.

The step of controlling the brightness of the panel includes the steps of if it is determined that the sensed brightness is bright, applying a large number of sustain pulses in a sustain period of sub-fields, and if it is determined that the sensed brightness is dark, applying a small number of sustain pulses in the sustain period of the sub-fields.

If it is determined that the sensed brightness is dark, the gray scale is represented using the i (i is natural number) number of the sub-fields, and if it is determined that the sensed brightness is bright, the gray scale is represented using the j (j is natural number) of the sub-fields, which is smaller than I, in order to secure a time where the large number of the sustain pulses can be provided.

The step of controlling the brightness of the panel includes if it is determined that the sensed brightness is bright, implementing the gray scale of an image using the j (j is natural number) of the gray scale, and if it is determined that the sensed brightness is dark, implementing the gray scale of an image using the i number (i is natural number) of the gray scale.

According to the present invention, there is provided an apparatus for driving a plasma display panel, including: a plurality of driving units for driving electrodes formed in the panel, a timing controller for controlling the driving units, and a brightness sensor for sensing the ambient brightness at a location where the panel is disposed, wherein the timing controller controls the driving units corresponding to the ambient brightness received from the brightness sensor.

The timing controller controls the driving units so that the panel displays an image of a high brightness when the sensed brightness received from the brightness sensor is bright, and controls the driving units so that the panel displays an image of a low brightness when the sensed brightness received from the brightness sensor is dark.

The timing controller controls the driving units so that a reset pulse is not applied in one or more of a plurality of sub-fields included in one frame, when the sensed brightness is dark.

The timing controller controls the driving units so that the reset pulse is applied only in odd-numbered sub-fields of the plurality of the sub-fields.

The timing controller controls the driving units so that an erase pulse is not applied in a sustain period of the odd-numbered sub-fields.

The timing controller controls the driving units to supply a reset pulse having a first voltage value during a reset period of sub-fields, if it is determined that the sensed brightness is not dark, and controls the driving units to supply a reset pulse having a second voltage value different from the first voltage value during the reset period of sub-fields, if it is determined that the sensed brightness is dark.

The second voltage value is set to be lower than the first voltage value.

The timing controller controls the driving units so that a large number of sustain pulses is applied in a sustain period of sub-fields, if it is determined that the sensed brightness is bright, and controls the driving units so that a small number of sustain pulses is applied in the sustain period of the sub-fields, if it is determined that the sensed brightness is dark.

According to the present invention, there is provided an apparatus for driving a plasma display panel, including: a plurality of driving units for driving electrodes formed in the panel, a sub-field mapping unit for mapping data received from the outside to sub-field patterns stored therein and supplying the mapped results to one of the driving units, and a brightness sensor for sensing the ambient brightness at a location where the panel is disposed, wherein the sub-field mapping unit maps the data so that the number of the gray scale is converted corresponding to the ambient brightness received from the brightness sensor.

The sub-field mapping unit comprises two or more sub-field tables so that the data can be mapped as a number of the gray scales.

The sub-field mapping unit maps the data so that the gray scale of an image can be implemented using the j number (j is natural number) of the gray scale, if it is determined that the sensed brightness is bright, and maps the data so that the gray scale of an image can be implemented using the i number (i is natural number) of the gray scale, which is greater than j, if it is determined that the sensed brightness is dark.

According to the present invention, there is provided an apparatus for driving a plasma display panel, including: a plurality of driving units for driving electrodes formed in the panel, a gain control unit for controlling a gain of data received externally, and a brightness sensor for sensing the ambient brightness at a location where the panel is disposed, wherein the gain control unit controls a gain value in order to expand or shrink the range of the gray scale to display an image corresponding to the ambient brightness received from the brightness sensor.

The gain control unit controls the gain value so that the range of the gray scale is shrunk, if it is determined that the sensed brightness is bright, and controls the gain value so that the range of the gray scale is expanded, if it is determined that the sensed brightness is dark.

The gain control unit controls the gain value so that the gain value when it is determined that the sensed brightness is dark is higher than the gain value when it is determined that the sensed brightness is bright.

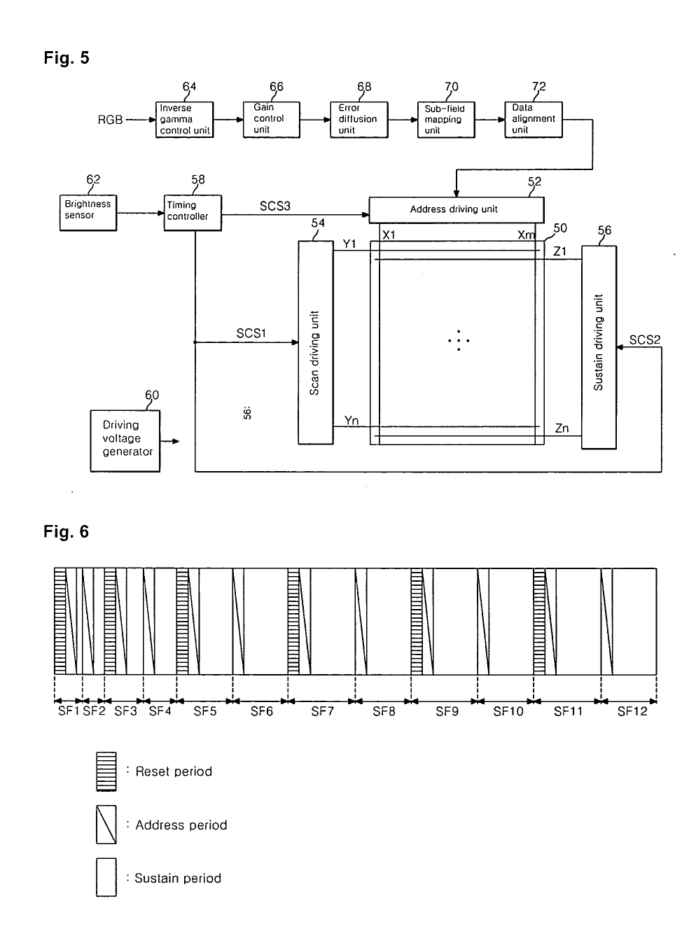

FIG. 5 is a block diagram showing an apparatus for driving a PDP according to an embodiment of the present invention.

Referring to FIG. 5, the apparatus for driving the PDP according to an embodiment of the present invention includes a address driving unit 52 for driving address electrodes X1 to Xm disposed in a panel 50, a scan driving unit 54 for driving scan electrodes Y1 to Yn disposed in the panel 50, a sustain driving unit 56 for driving sustain electrodes Z1 to Zn disposed in the panel 50, a driving voltage generator 60 for supplying driving voltages to the driving units 52, 54 and 56, a timing controller 58 for supplying control signals SCS1 to SCS3 to the driving units 52, 54 and 56, and a brightness sensor 62 for sensing a brightness of a location where the panel 50 is disposed.

The driving voltage generator 60 generates a variety of voltages and supplies the generated voltages to the address driving unit 52, the scan driving unit 54 and the sustain driving unit 56 so that driving waveforms of various voltages can be generated.

The brightness sensor 62 senses the ambient brightness at a location where the panel 50 is driven and applies a signal corresponding to the sensed brightness to the timing controller 58.

The timing controller 58 generates a variety of switching control signals, and applies them to the address driving unit 52, the scan driving unit 54 and the sustain driving unit 56 so that driving waveforms can be generated from the driving units 52, 54 and 56. For example, the timing controller 58 generates a first switching control signal SCS1 and applies it to the scan driving unit 54, and it generates a second switching control signal SCS2 and applies it to the sustain driving unit 56. Further, the timing controller 58 generates a third switching control signal SCS3 and applies it to the address driving unit 52. In this time, the timing controller 58 generates the switching control signals SCS1 to SCS3 so that a variety of driving waveforms can be supplied corresponding to a signal supplied from the brightness sensor 62. In reality, the driving waveforms supplied under the control of the timing controller 58 will be described later on.

The address driving unit 52 supplies image data data received from the outside to the address electrodes X1 to Xm according to the third switching control signal SCS3 of the timing controller 58.

The scan driving unit 54 applies a reset pulse, a scan pulse scan and a sustain pulse sus to the scan electrodes Y1 to Ym, according to the first switching control signal SCS1 received from the timing controller 58.

The sustain driving unit 56 applies a positive polarity voltage (Vs), a sustain pulse sus and an erase pulse erase to the sustain electrodes Z1 to Zm, according to the second switching control signal SCS2 received from the timing controller 58.

Meanwhile, the driving apparatus according to the present invention further includes an inverse gamma control unit 64, a gain control unit 66, an error diffusion unit 68, a sub-field mapping unit 70 and a data alignment unit 72.

The inverse gamma control unit 64 performs an inverse gamma correction operation on digital data RGB received externally, thereby linearly converting the brightness for the gray scale of a picture signal. The gain control unit 66 controls an effective gain by the data of R (read), G (green) and B (blue) to compensate for color temperature. The error diffusion unit 68 minutely controls the brightness value by diffusing quantization error of digital video data RGB received from the gain control unit 66 to neighboring cells. The sub-field mapping unit 70 maps data received from the error diffusion unit 68 to predetermined sub-field patterns stored therein on a per bit basis, and then supplies the mapped data to the data alignment unit 72. The data alignment unit 72 realigns digital video data received from the sub-field mapping unit 70 and supplies them to the address driving unit 52.

In the driving apparatus constructed above, the driving waveforms supplied under the control of the timing controller 58 will now be described in detail.

First, the timing controller 58 receives the ambient brightness from the brightness sensor 62. In this time, if it is determined that the ambient brightness received from the brightness sensor 62 is dark, the timing controller 58 controls the black brightness to be dark by not applying the reset pulse in one or more of a plurality of sub-fields (12 sub-fields SF1 to SF12 in FIG. 6) as shown in FIG. 6.

For example, the timing controller 58 applies the reset pulse in the odd-numbered sub-fields SF1, SF3, SF5, . . . , SF11, but does not apply the reset pulse in the even-numbered sub-fields SF2, SF4, SF6, . . . , SF12, as shown in FIG. 6. As such, if the reset pulse is applied only in the odd-numbered sub-fields SF1, SF3, SF5, . . . , SF11, the amount of light generated by the reset pulse during one frame is reduced. Accordingly, contrast can be improved. Particularly, in the case where the ambient brightness is dark, if the reset pulse is applied only in the odd-numbered sub-fields SF1, SF3, SF5, . . . , SF11, the black brightness is represented very dark. Thus, a viewer can easily view the dark screen.

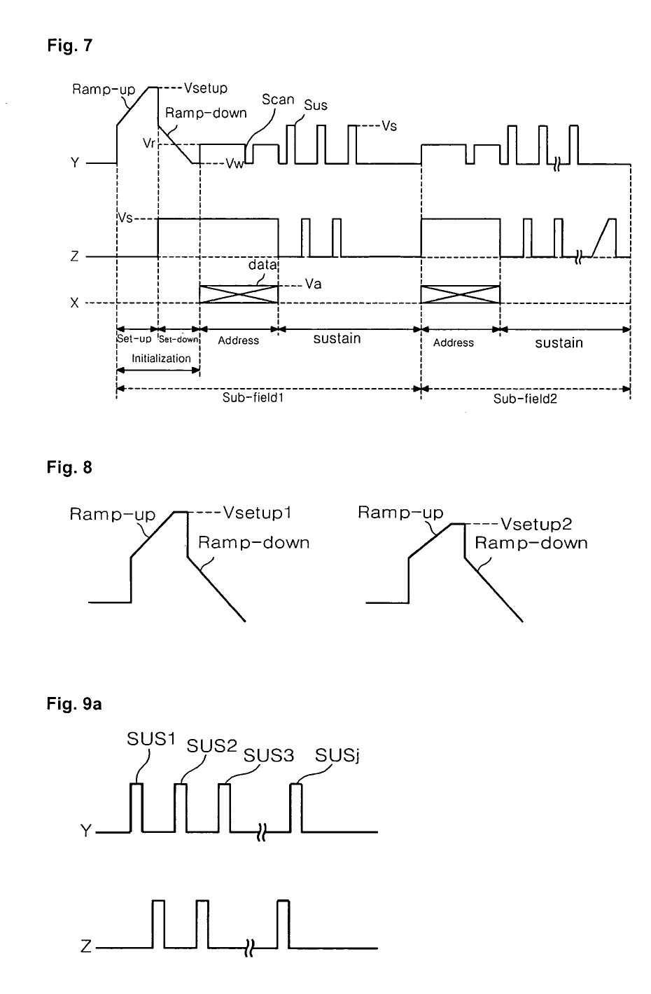

Meanwhile, if the reset pulse is applied only in the odd-numbered sub-fields SF1, SF3, SF5, . . . , SF11, a discharge in the even-numbered sub-fields SF2, SF4, SF6, . . . , SF12 can be generated unstably. Therefore, in the present invention, as shown in FIG. 7, the erase pulse is not applied in the sustain period of the odd-numbered sub-fields SF1, SF3, SF5, . . . , SF11. If the erase pulse is not applied as such, an address operation can be performed in next sub-fields using wall charges of discharge cells since the wall charges are not erased. Meanwhile, the driving waveforms applied in the initialization period and the address period except for the sustain period are the same as those described with reference to FIG. 4. Thus, description on them will be omitted for simplicity.

Meanwhile, if it is determined that the ambient brightness received from the brightness sensor 62 is dark, the timing controller 58 can make the black brightness dark by lowering the reset pulse, i.e., the voltage values of the ramp-up pulse Ramp-up and the ramp-down pulse Ramp-down, as shown in FIG. 8.

In other words, if it is determined that the ambient brightness is not dark, the timing controller 58 applies a reset pulse having a first voltage Vsetup1 to initialize the discharge cells. Further, if it is determined that the ambient brightness is dark, the timing controller 58 applies a reset pulse having a second voltage Vsetup2 lower than the first voltage Vsetup1 to initialize the discharge cells. In this time, if the reset pulse having a low voltage Vsetup2 is applied, the amount of light generated by the reset pulse is reduced and contrast can be thus improved.

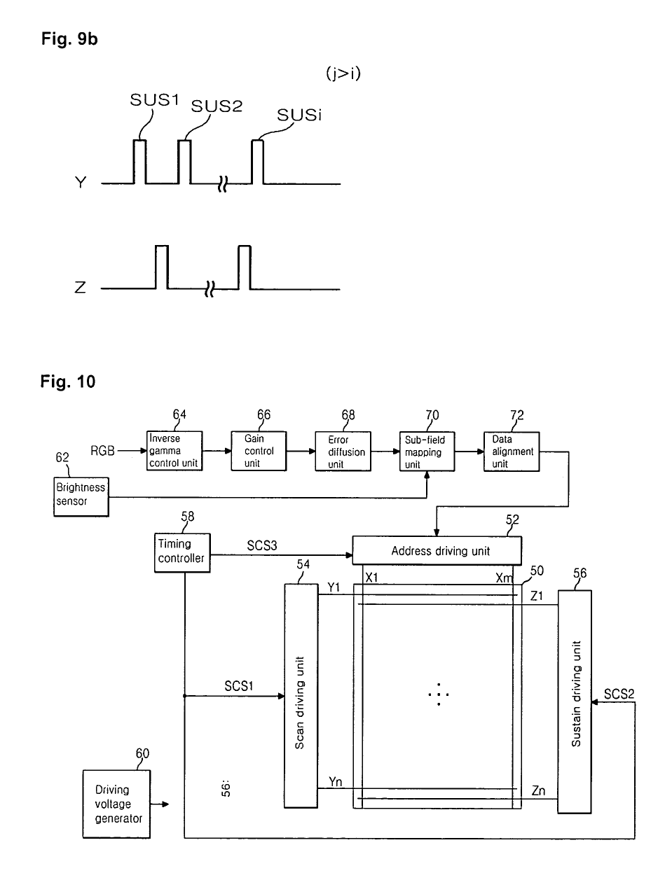

Moreover, the timing controller 58 can control the number of the sustain pulse so that the screen of an optimum brightness can be displayed in correspondence to the ambient brightness. That is, if it is determined that the ambient brightness is bright, the timing controller 58 controls greater sustain pulses to be supplied to the respective sub-fields. For example, if it is determined that the ambient brightness is bright, the timing controller 58 applies the j number (where, j is natural number) of sustain pulses to the scan electrodes Y in specific sub-fields, as shown in FIG. 9a. (where, the sustain pulses are alternately applied to the sustain electrodes Z and the scan electrodes Y) If many sustain pulses are applied when the ambient brightness is bright as such, the brightness of an image displayed on the panel 50 is increased. Thus, a viewer can easily view the bright screen. That is, in the present invention, if the ambient brightness is bright, a lot of sustain pulses is supplied. Thus, an optimum brightness can be provided to a viewer.

Furthermore, if it is determined that the ambient brightness is dark, the timing controller 58 controls less sustain pulses to be supplied to respective sub-fields. For example, if it is determined that the ambient brightness is dark, the timing controller 58 supplies the i number (where, i is natural number) of sustain pulses, which is smaller than the number j, to the scan electrodes Y in specific sub-fields, as shown in FIG. 9b. If less sustain pulses are supplied when the ambient brightness is dark as such, the brightness of an image displayed on the panel 50 is reduced. Thus, a viewer can easily view the image displayed on the panel 50 even in a dark ambient environment. That is, in the present invention, if the ambient brightness is dark, less sustain pulses are supplied. Accordingly, an optimum brightness can be provided to a viewer.

Meanwhile, it has been described that a greater number of sustain pulses is applied when the ambient brightness is bright. However, the number of a sustain pulse, which can be supplied in a limited sub-field period, is limited. Accordingly, in the present invention, in the case where lots of sustain pulses is applied, one or more of the sub-fields included in one frame can be removed. For example, when the screen is normally displayed, the gray scale can be represented using 12 sub-fields. When the ambient brightness is bright, the gray scale can be represented using 10 sub-fields. In this time, when the ambient brightness is bright, the brightness displayed on the panel 50 can be increased by further supplying the number of the sustain pulses as much as the time of two sub-fields.

FIG. 10 is a block diagram showing an apparatus for driving a PDP according to another embodiment of the present invention.

Referring to FIG. 10, it can be seen the apparatus according to this embodiment has the same components as those of FIG. 5 except that a signal from the brightness sensor 62 is applied to the sub-field mapping unit 70.

The sub-field mapping unit 70 receives a signal corresponding to the ambient brightness from the brightness sensor 62. The sub-field mapping unit 70 then adjusts the number of a gray scale corresponding to the brightness. This will be below described in detail. If the ambient brightness is dark, a viewer can easily notice a small difference in brightness. Thus, if the number of the gray scale falls short, the viewer can easily view degraded picture quality. In this connection, the sub-field mapping unit 70 maps data so that the image can be displayed with a large number of gray scales when the ambient brightness is dark. For example, the sub-field mapping unit 70 maps sub-fields so that the image can be displayed with 1024 gray scales when the ambient brightness is dark.

Furthermore, if the ambient brightness is bright, a view cannot easily notice a different in brightness although lots of gray scales are not used. Accordingly, the sub-field mapping unit 70 maps data so that an image can be displayed with a small number of gray scales when the ambient brightness is bright. (In this case, the number of the gray scale may vary depending on various external factors, environments, etc.) For example, the sub-field mapping unit 70 maps sub-fields so that an image is displayed with 256 gray scales when the ambient brightness is bright.

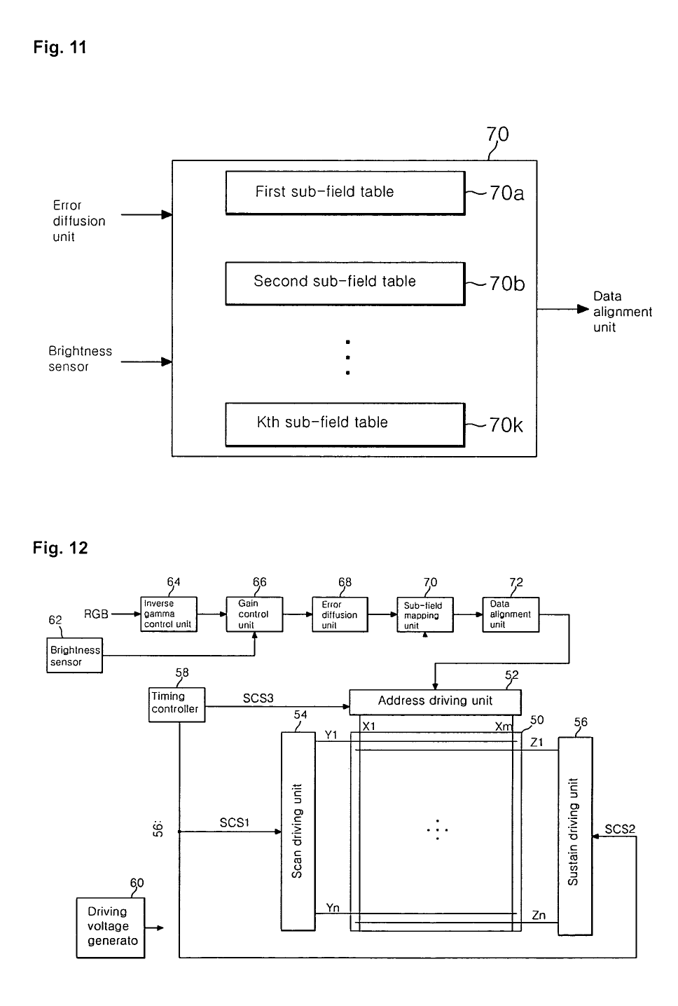

To this end, the sub-field mapping unit 70 includes two or more sub-field tables 70a, 70b and 70k, as shown in FIG. 11. The sub-field tables 70a, 70b and 70k store different sub-field mapping tables. For example, the first sub-field table 70a maps data so that 256 gray scales can be displayed on the panel 50 (for example, using 8 sub-fields). The second sub-field table 70b maps data so that 512 gray scales can be displayed on the panel 50 (for example, using 10 sub-fields). Also, a kth sub-field table 70k maps data so that 1024 gray scales can be displayed on the panel 50 (for example, using 12 sub-fields) That is, the sub-field mapping unit 70 maps data using one of the sub-field tables 70a, 70b and 70k corresponding to the ambient brightness, thus adjusting the number of the gray scale corresponding to the ambient brightness.

FIG. 12 is a block diagram showing an apparatus for driving a PDP according to still another embodiment of the present invention.

Referring to FIG. 12, it can be seen the apparatus according to this embodiment has the same components as those of FIG. 5 except that a signal from a brightness sensor 62 is applied to a gain control unit 66.

The gain control unit 66 receives a signal corresponding to the ambient brightness from the brightness sensor 62. The gain control unit 66 then adjusts a gain value (the number of a gray scale) corresponding to the brightness. In other words, the gain control unit 66 controls an image to be displayed within the range of a wide gray scale when the ambient brightness is dark, and controls an image to be displayed within the range of a narrow gray scale when the ambient brightness is bright.

This will be now described in detail. The gain control unit 66 finds a gain corresponding to input data using the following equation.
Gain =b/255×(the number of gray scale-1)

In the equation, “b” indicates the gray scale value of data which is inputted to the gain control unit 66. “255” indicates a maximum gray scale value which can be inputted (where, for explanation's convenience, the maximum gray scale value is set to 255). Furthermore, “the number of gray scale” indicates the number of the gray scale which can be represented. For example, assuming that 256 gray scales can be represented and the gray scale value of data inputted currently is 1, the gain is set to “1”. In addition, if the gray scale value of data inputted currently is 255, the gain is set to “255”.

In this time, the gain control unit 66 can widen or narrow the range of the gray scale which can be represented by adjusting the number of the gray scale. For example, the gain control unit 66 can obtain the gain of “1” to “255” by setting the number of the gray scale to 255 when the ambient brightness is bright, and can display an image using the obtained gain value. Furthermore, the gain control unit 66 can obtain the gain of “2” to “511” by setting the number of the gray scale to be high, for example, 511, when the ambient brightness is dark. If the value of the gain increases as such, the range of the gray scale which can be represented widens and an image can be thus displayed using a wide range of the gray scale. Through this method, the gain control unit 66 adjusts the gain corresponding to the ambient brightness, so that an image of an optimum brightness can be displayed on the panel 50.

Meanwhile, according to the present invention, it is to be noted that a variety of two or more embodiments can be applied at the same time. For example, the brightness of an image displayed on the panel 50 can be controlled by adjusting the number of the reset pulse while increasing the number of the gray scale. Furthermore, the brightness of an image displayed on the panel 50 can be controlled by adjusting the number of the reset pulse and the number of the sustain pulse.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A method for driving a plasma display panel, comprising the steps of:
(a) sensing the ambient brightness at a location where the panel is disposed; and
(b) controlling the brightness of the panel corresponding to the sensed brightness.

2. The method as claimed in claim 1, wherein the step of controlling the brightness of the panel includes controlling the brightness of the panel to be bright when the sensed brightness is bright, and controlling the brightness of the panel to be dark when the sensed brightness is dark.

3. The method as claimed in claim 1, wherein the step of controlling the brightness of the panel includes not applying a reset pulse in one or more of a plurality of sub-fields included in one frame when the sensed brightness is dark.

4. The method as claimed in claim 3, wherein the reset pulse is applied in odd-numbered sub-fields of the plurality of the sub-fields, and the reset pulse is not applied in the remaining sub-fields.

5. The method as claimed in claim 4, wherein in a sustain period of the odd-numbered sub-fields, an erase pulse is not applied.

6. The method as claimed in claim 1, wherein the step of controlling the brightness of the panel comprises the steps of:
if it is determined that the sensed brightness is not dark, applying a reset pulse having a first voltage value during a reset period of sub-fields; and
if it is determined that the sensed brightness is dark, applying a reset pulse having a second voltage value different from the first voltage value during the reset period.

7. The method as claimed in claim 6, wherein the second voltage value is set to be lower than the first voltage value.

8. The method as claimed in claim 1, wherein the step of controlling the brightness of the panel comprises the steps of:
if it is determined that the sensed brightness is bright, applying a large number of sustain pulses in a sustain period of sub-fields; and
if it is determined that the sensed brightness is dark, applying a small number of sustain pulses in the sustain period of the sub-fields.

9. The method as claimed in claim 8, wherein if it is determined that the sensed brightness is dark, the gray scale is represented using the i (i is natural number) number of the sub-fields, and
if it is determined that the sensed brightness is bright, the gray scale is represented using the j (j is natural number) of the sub-fields, which is smaller than I, in order to secure a time where the large number of the sustain pulses can be provided.

10. The method as claimed in claim 1, wherein the step of controlling the brightness of the panel includes:
if it is determined that the sensed brightness is bright, implementing the gray scale of an image using the j (j is natural number) of the gray scale, and
if it is determined that the sensed brightness is dark, implementing the gray scale of an image using the i number (i is natural number) of the gray scale.

11. An apparatus for driving a plasma display panel, comprising:
a plurality of driving units for driving electrodes formed in the panel;
a timing controller for controlling the driving units; and
a brightness sensor for sensing the ambient brightness at a location where the panel is disposed,
wherein the timing controller controls the driving units corresponding to the ambient brightness received from the brightness sensor.

12. The apparatus as claimed in claim 11, wherein the timing controller controls the driving units so that the panel displays an image of a high brightness when the sensed brightness received from the brightness sensor is bright, and controls the driving units so that the panel displays an image of a low brightness when the sensed brightness received from the brightness sensor is dark.

13. The apparatus as claimed in claim 11, wherein the timing controller controls the driving units so that a reset pulse is not applied in one or more of a plurality of sub-fields included in one frame, when the sensed brightness is dark.

14. The apparatus as claimed in claim 13, wherein the timing controller controls the driving units so that the reset pulse is applied only in odd-numbered sub-fields of the plurality of the sub-fields.

15. The apparatus as claimed in claim 14, wherein the timing controller controls the driving units so that an erase pulse is not applied in a sustain period of the odd-numbered sub-fields.

16. The apparatus as claimed in claim 11, wherein the timing controller controls the driving units to supply a reset pulse having a first voltage value during a reset period of sub-fields, if it is determined that the sensed brightness is not dark, and controls the driving units to supply a reset pulse having a second voltage value different from the first voltage value during the reset period of sub-fields, if it is determined that the sensed brightness is dark.

17. The apparatus as claimed in claim 16, wherein the second voltage value is set to be lower than the first voltage value.

18. The apparatus as claimed in claim 11, wherein the timing controller controls the driving units so that a large number of sustain pulses is applied in a sustain period of sub-fields, if it is determined that the sensed brightness is bright, and controls the driving units so that a small number of sustain pulses is applied in the sustain period of the sub-fields, if it is determined that the sensed brightness is dark.

19. An apparatus for driving a plasma display panel, comprising:
a plurality of driving units for driving electrodes formed in the panel;
a sub-field mapping unit for mapping data received from the outside to sub-field patterns stored therein and supplying the mapped results to one of the driving units; and
a brightness sensor for sensing the ambient brightness at a location where the panel is disposed,
wherein the sub-field mapping unit maps the data so that the number of the gray scale is converted corresponding to the ambient brightness received from the brightness sensor.

20. The apparatus as claimed in claim 19, wherein the sub-field mapping unit comprises two or more sub-field tables so that the data can be mapped as a number of the gray scales.

21. The apparatus as claimed in claim 20, wherein the sub-field mapping unit maps the data so that the gray scale of an image can be implemented using the j number (j is natural number) of the gray scale, if it is determined that the sensed brightness is bright, and maps the data so that the gray scale of an image can be implemented using the i number (i is natural number) of the gray scale, which is greater than j, if it is determined that the sensed brightness is dark.

22. An apparatus for driving a plasma display panel, comprising:
a plurality of driving units for driving electrodes formed in the panel;
a gain control unit for controlling a gain of data received externally; and
a brightness sensor for sensing the ambient brightness at a location where the panel is disposed,
wherein the gain control unit controls a gain value in order to expand or shrink the range of the gray scale to display an image corresponding to the ambient brightness received from the brightness sensor.

23. The apparatus as claimed in claim 22, wherein the gain control unit controls the gain value so that the range of the gray scale is shrunk, if it is determined that the sensed brightness is bright, and controls the gain value so that the range of the gray scale is expanded, if it is determined that the sensed brightness is dark.

24. The apparatus as claimed in claim 23, wherein the gain control unit controls the gain value so that the gain value when it is determined that the sensed brightness is dark is higher than the gain value when it is determined that the sensed brightness is bright.
